(19) United States
(12) Patent Application Publication
(10) Pub. No.: US 2025/0062600 A1
(43) Pub. Date: Feb. 20, 2025

(54) Cable Lifter

(71) Applicant: Ricardo Antilus, West Palm Beach, FL (US)

(72) Inventor: Ricardo Antilus, West Palm Beach, FL (US)

(21) Appl. No.: 18/234,298

(22) Filed: Aug. 15, 2023

(51) Int. Cl. H02G 1/04; H02G 11/00

(52) U.S. Cl. CPC H02G 1/04; H02G 11/00

(57) ABSTRACT

A cable lifter for lifting different size cables. The inventing device includes three holes for attaching cables to carry up and down power line poles or similar applications such as trees, roofs, etc. As well as a panel that is adjustable that may attach to various operating machines. The cable lifter material may be made of carbon fiber, steel, and or fiber glass to help with saving weight.

### BACKGROUNG OF THE INVENTION

### (1) Field of Invention

This device pertains to lifting and balancing a load.

### BRIEF SUMMARY OF THE INVENTION

In the aspect disclosed herein, a device to lift cable is disclosed. The cable lifter has clamping holes that clamp cables to lift in the air. The cable lifter may have different sizes of clamping holes to accommodate different sizes of cable. The cable lifter is attached to the bucket truck and have holes to fasten screws for tightening device for firmness.

### DETAILS DESCRIPTION OF THE INVENTION

The purpose of this tool is to give field workers (lineman, journeymen, etc.) the ability to lift, load, and transport cables (primary, secondary, feeder, and so on) on an electric. light, and or tree poles. Linemen used their hands to grab cables from the ground and carry those cables up in their bucket trucks to connect to the power lines. The problem with that technique is that the linemen not only have to carry the cables one by one, but also, go back down each time for each cable (a total of 3). The cable lifter will erase these onnecessary steps and get the job done faster and easier.

### Job Description/Needed

Harding is what field workers (lineman, Journeyman, etc.) do when giving a job to connect underground cable up the electric poles. Harding is required for power. A bucket truck is always needed to do this job. Usually, the worker must take the cable in his/her hands while standing inside the bucket at the poles. The cables depend on the size and height of the poles. Either way, the cables are heavy. Another reason is when the worker is up in the bucket near the pole, they need both of their hands to function properly and perform other tasks. The cable lifter eliminates workers carrying the weights of the cables and give them free hands and space to operate.

### How the Tool Works for Workers

Cables (Primary, Secondary, Feeder, and so on) have different sizes, weights, and lengths. The cable lifter has 3 holes to attach cables freely. The 3 holes can be different sizes to accommodate any cable. The holes are 1 inch to 5 inches in size. There are adjustment screws to tighten the holes once closed. That is how the cables hang without falling off the bucket truck. There is a panel to hold the device together. That panel is attached to the bucket truck for support. It has a pad, so the inside of the bucket doesn't get damaged (scratches, dents, and so on). It also has two serews on the outside so it can squeeze into the bucket truck. The worker, on the ground, attaches the device to the bucket truck, tightens the cables and goes up the pole.

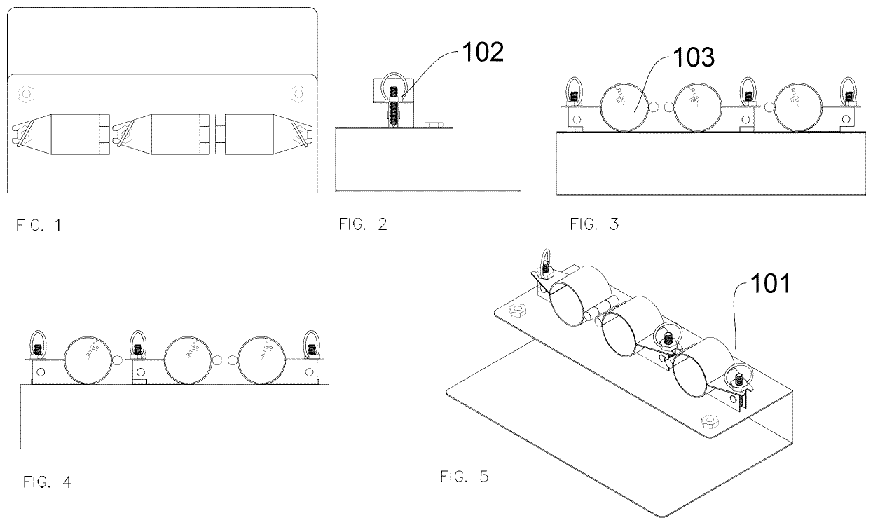

FIG. 1—is the top view of the device. It contains the top screws that faster the holes clamps to the cable.

FIG. 2—is the side view of the device. It shows how deep the screws are attached to the device.

FIG 3—is the book view of the device. It shows the back holes and how the cables fit inside.

FIG. 4—Is the front view of the device. It shows how the device looks from the front.

FIG. 5—is the full view of the device: It shows the complete view. The way the screws, holes, and clamps are viewed when sitting still.

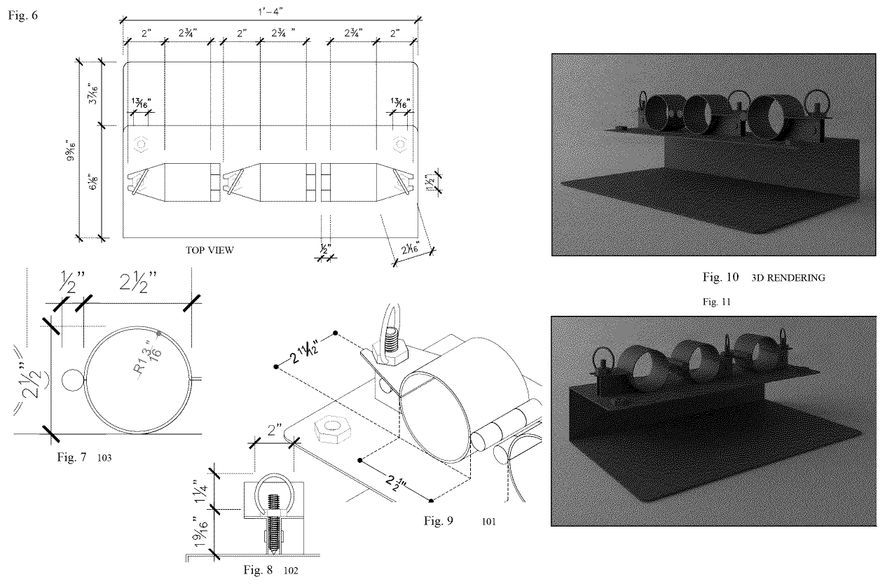

FIG. 6, 7, 8 and 9—are the measurements of the device.

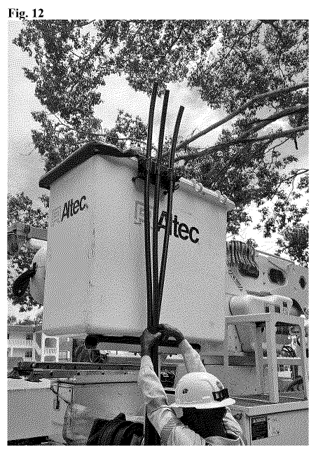

FIG. 10 and 11—are the 3D modeling of the actual device.

FIG. 12—is the actual device in the field being tested.

The second page is the 3D model and the measurement of the device.

1. A cable lifter for lifting cables, the cable lifter compromising:
(a) a series of clamping holes with attaching screws; wherein said clamping holes with screws are attached to the square body for support.
(b) a square body that may fit any vehicle specifically designed for that said vehicle.
(c) a small hole is added at the top each corner of the square body to ground the cable lifter in case in use next to a power line; wherein these small holes may be used in conjunction with screws for tightening the cable lifter to any designed vehicle for added stability.
